(19) United States
(12) Patent Application Publication
(10) Pub. No.: US 2004/0060654 A1
(43) Pub. Date: Apr. 1, 2004

(54) Method of mechanical processing

(76) Inventors: Kenso Kanada, Chiryu-city (JP); Kazuhiko Ikai, Takahama-city (JP)

Correspondence Address: HARNESS, DICKEY & PIERCE, P.L.C., P.O. BOX 828, BLOOMFIELD HILLS, MI, 48303, US

(21) Appl. No.: 10/668,703

(22) Filed: Sep. 23, 2003

(30) Foreign Application Priority Data
Sep. 27, 2002 (JP) 2002-283140
May 27, 2003 (JP) 2003-149517

(51) Int. Cl. B32B 31/20

(52) U.S. Cl. 156/306.6; 156/309.9

(57) ABSTRACT

In a method of mechanical processing in which mechanical processing is performed while a coolant 19 is sprinkled over a workpiece 13 fastened to a fixing surface using a coagulating agent, any agent having melting point equal to or higher than ordinary temperature from among calcium nitrate tetrahydrate, polyethylene glycol, and paraffin is used as the coagulating agent 12 for fastening the workpiece 13 to a workpiece-fastening stage 14 as the fixing surface, the coagulating agent 12 being solidified to thereby fasten the workpiece 13 to the workpiece-fastening stage 14, and a coolant 19 at an ordinary temperature is used.

### BACKGROUND OF THE INVENTION

1. Field of the Invention

The present invention relates to a method of performing mechanical processing on a workpiece fastened to a fixing surface while sprinkling a coolant on the workpiece and, more preferably, to a method of mechanical processing that can be applied to cases where mechanical processing such as cutting is performed by fastening a workpiece made of a material such as stainless steel, non-ferrous metal, ceramics, etc. for which a magnet type fastener for fastening a workpiece cannot be used, especially to cases where a thin plate or a weak, fragile article is to be fastened for mechanical processing.

2. Description of the Related Art

One of the methods conventionally used for fastening a workpiece such as a thin plate or an article of fragile shape for mechanical processing is to employ a freeze chuck (see, Japanese Pat. No. 2992770). A freeze chuck uses silicone oil type coagulating agent with a melting point of about 17° C.

However, when conventional silicone oil is used as the coagulating agent, problems arise as silicone oil is an expensive material, and moreover, it is an environmental burden and may give rise to a pollution.

### SUMMARY OF THE INVENTION

It is an object of the present invention to overcome above-mentioned problems and to provide a method of performing mechanical processing using a coagulating agent (fastening agent) for fastening a workpiece to a fixing surface while sprinkling a coolant on the workpiece, a method which is inexpensive compared to conventional methods and is free of environmental contamination.

The present invention has been made after intensive study conducted on coagulating agents (fastening agents), separately, in cases where the coolant (machining liquid) is used at an ordinary temperature and in cases where the coolant is used below an ordinary temperature. The term “ordinary temperature”, as used herein, refers to an ordinary temperature at which the mechanical processing of this type is usually carried out, for example, about 20˜30° C.

According to an aspect of the present invention, there is provided a method of performing mechanical processing while a coolant (19) is sprinkled on a workpiece (13) fastened to a fixing surface (14) for fastening, wherein a fastening agent (coagulating agent) (12) selected from the group consisting of calcium nitrate tetrahydrate, polyethylene glycol, and paraffin, and having a melting point equal to or higher than ordinary temperature is used for fastening a workpiece to the fixing surface (14) for fastening, with the workpiece being fastened to the fixing surface by coagulation of the fastening agent using the coolant in the state at an ordinary temperature.

In the method of the present invention, the fixing surface is heated to temperature equal to or higher than the melting point of the fastening agent, and the fastening agent is disposed on the fixing surface, and when the fastening agent is in molten state, a workpiece is placed on it and temperature is returned to an ordinary temperature for the fastening agent to solidify and to thereby fasten the workpiece to the fixing surface. Thereafter, there is no problem in performing mechanical processing using the coolant at ordinary temperature. Thus, in the method of the present invention, it is not required to cool the fixing surface and the coolant.

Processing at an ordinary temperature is advantageous in that there is little warp in products and that dimensional error is also small. Calcium nitrate tetrahydrate, polyethylene glycol, and paraffins are fastening agents that have been found by the present inventor after intensive study to be inexpensive, to be friendly to environment and to pose no problem of pollution.

Therefore, according to the present invention, in mechanical processing that uses a coagulating agent (fastening agent) to fasten a workpiece to a fixing surface, and is performed with a coolant sprinkled on the workpiece, there is provided a method of performing mechanical processing which is inexpensive compared to conventional methods and which is free of environmental contamination.

According to another aspect of the present invention, in a method of mechanical processing that is performed while sprinkling a coolant (19) on a workpiece (13) fastened on a fixing surface (14) for fastening, any one of polyethylene glycol and paraffins and having a melting point not lower than 0° C. and not higher than ordinary temperature, is used as a fastening agent (coagulating agent) (12) for fastening the workpiece to the fixing surface, and after the workpiece and the fastening agent in liquid state are disposed on the fixing surface, a coolant is used at temperature not higher than ordinary temperature for the fastening agent to solidify and to thereby fasten the workpiece to the fixing surface.

As the fastening agent which has a melting point not lower than 0° C. and not higher than ordinary temperature is in liquid state at ordinary temperature, fastening of a workpiece can be achieved by disposing at ordinary temperature, the fastening agent in liquid state and the workpiece on the fixing surface, and prior to actually performing mechanical processing, using a coolant at a temperature below ordinary temperature for the fastening agent to be cooled and to solidify. Thereafter, there is no problem in performing mechanical processing using the coolant below ordinary temperature.

In the present invention, it is necessary to cool the coolant below ordinary temperature in order to cause the fastening agent to solidify. As the temperature for the fastening agent to solidify is not lower than 0° C., though not higher than ordinary temperature, large scale cooling equipment is not required for cooling the coolant. More specifically, it suffices to use a general purpose cooling apparatus such as an immersion cooler.

As in the above-described aspect, polyethylene glycol and paraffins having a melting point not lower than 0° C. and not higher than ordinary temperature, have been found to be inexpensive and environment-friendly fastening agents, which are free of pollution, by the present inventors, as a result of an intensive study.

Therefore, also with the present invention, in mechanical processing that uses a coagulating agent (fastening agent) to fasten a workpiece to a fixing surface, and is performed with a coolant sprinkled on the workpiece, there is provided a method of performing mechanical processing which is inexpensive compared to conventional methods and which is free of environmental contamination.

The present invention may be more fully understood from the description of preferred embodiments of the invention, as set forth below, together with the accompanying drawings.

### BRIEF DESCRIPTION OF THE DRAWINGS

In the drawings:

FIG. 1 is a schematic view showing the construction of a processing apparatus used in a mechanical processing method according to an embodiment of the present invention;

FIG. 2 is an enlarged view showing a vicinity of the workpiece-fastening stage of FIG. 1; and

FIG. 3 is a view showing a method for measuring adhesion strength of the coagulating agent (fastening agent).

### DESCRIPTION OF THE PREFERRED EMBODIMENTS

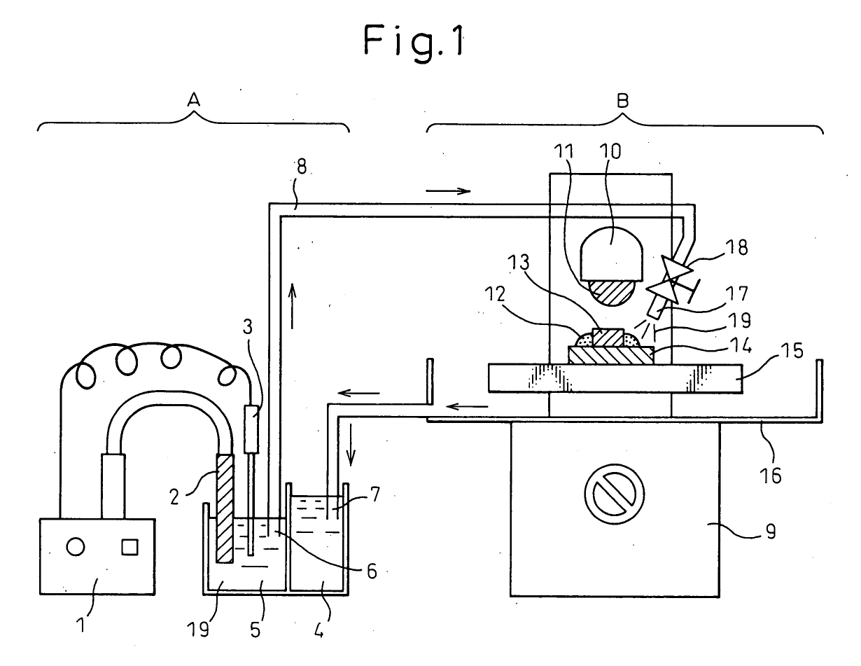

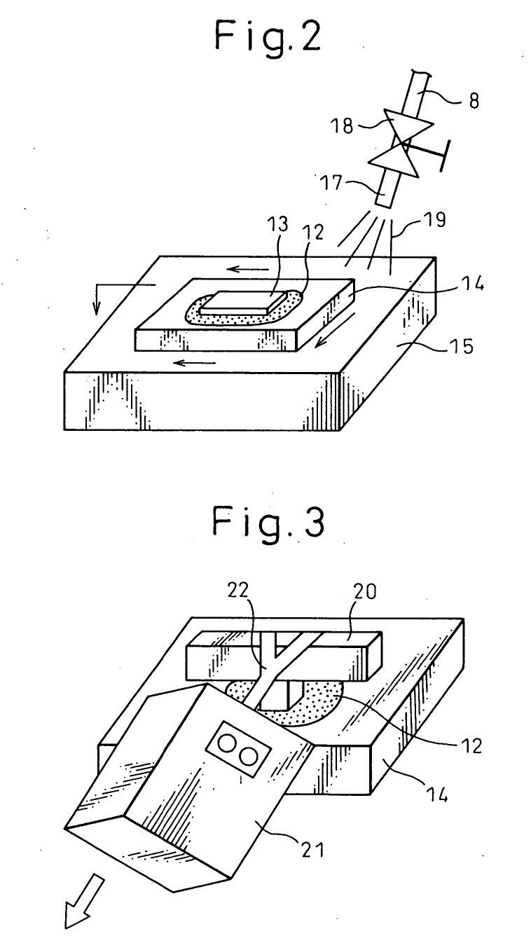

The present invention will now be described with reference to drawings showing embodiments thereof. FIG. 1 is a schematic view showing the overall construction of a processing apparatus used in a mechanical processing method according to an embodiment of the present invention. FIG. 2 is an enlarged view showing a vicinity of a workpiece-fastening stage 14 in FIG. 1.

The apparatus shown in FIG. 1 is composed broadly of a coolant storage section A for storing a coolant 19 and a workpiece processing section B for fastening a workpiece 13 and for mechanical processing of same, with the coolant circulating between two sections A and B. Circulation of the coolant 19 is performed using a circulation pump (not shown), and the like, with a coolant hose 8 having a coolant suction port 6 and a coolant return port 7.

In FIG. 1, A main body 1 of an immersion cooler is a general purpose cooling apparatus having a cooling pipe 2 for cooling the coolant 19. The cooling pipe 2 is immersed in a coolant tank 5, and the main body 1 controls the temperature of the cooling pipe 2 to thereby cool the coolant 19 in the coolant tank 5.

A water temperature sensor 3 is provided in the main body 3 of the immersion cooler. The water temperature sensor 3 is provided for monitoring the temperature of the coolant 19 in the coolant tank 5. The water temperature sensor 3 and the main body 3 of the immersion cooler are interlocked with each other such that the coolant 19 can be maintained at a set temperature.

The coolant tank is composed of a first coolant sedimentation tank 4 and a second coolant sedimentation tank 5 separated from each other by a partition wall. The first coolant sedimentation tank 4 is a tank to which the coolant containing cutting debris is returned and stored via the coolant return port 7. The coolant is cleaned by filtration with a filter (not shown) and by settling of cutting debris down to the bottom of the first coolant sedimentation tank 4.

The supernatant of the cleaned coolant 19 in the first coolant sedimentation tank 4 flows over the above-mentioned partition wall into the second coolant sedimentation tank 5. The coolant 19 in the second coolant sedimentation tank 5 is sucked from the coolant suction port 6 at ordinary temperature, or in some cases, after being cooled to temperature below ordinary temperature by the above-mentioned coolant cooling apparatus 1, 2, and is again circulated to the workpiece processing section B.

As has been described above, the coolant storage section A is composed of the main body 1 of the immersion cooler and the cooling pipe 2, the water temperature sensor 3, and two sedimentation tanks 4, 5.

The workpiece processing section B comprises a main body 9 of a processing machine. On the main body 9 of the processing machine, there is provided a rotary grinding stone 11 having a grinding stone cover 10 for protection, and a workpiece 13 is fastened to a workpiece-fastening stage 14, as a fixing surface, via coagulating agent 12 as a fastening agent. The workpiece 13 is not particularly restricted, and a thin plate made of stainless steel, a non-ferrous metal, a ceramic, etc., or a weak, fragile article may be employed.

The workpiece-fastening stage 14 is constructed so as to be moved by a table 15 back and forth as well as left and right during mechanical processing of the workpiece 13.

Here, the workpiece 13 fastened to the workpiece-fastening stage 14 is subjected to cutting by the rotary grinding stone 11 while the coolant 19 is sprinkled on the workpiece 13, and cutting debris is removed by the coolant 19. A coolant reception tray 16 is provided under the workpiece-fastening stage 14 and the table 15 for receiving the coolant 19 during the processing.

The coolant 19 that is fed from the coolant storage section A through the coolant hose 8 to the workpiece processing section B, is sprayed from a coolant spraying port 17 attached to the coolant hose 8 and sprinkled onto the workpiece 13. The amount of outflow of the coolant 19 from the coolant spraying port 17 is controlled by a coolant switching cock 18.

As has been described above, the workpiece processing section B is composed substantially of the main body 9 of the processing machine, the grinding stone cover 10, the grinding stone 11, the workpiece-fastening stage 14, the table 15, the coolant reception tray 16, the coolant spraying port 17, and the coolant switching cock 18.

As has been described above, the coolant 19 circulates between the coolant storage section A and the workpiece processing section B. The coolant 19 sucked at the coolant suction port 6 in the storage section A is fed through the coolant hose 8 to the coolant spraying port 17 to be sprayed to the workpiece processing section B, and returned through the coolant return port 7 again to the storage section A.

Different coagulating agents 12 are used as fastening agent for fastening the workpiece 13 to the fixing surface according as the coolant 19 used in the mechanical processing is used at ordinary temperature or below ordinary temperature. The term “ordinary temperature” as used herein refers to room temperature of about 20˜30° C., for example 25° C. The method of mechanical processing for each of the two cases will be described below.

[Case Where Coolant is Used at Ordinary Temperature]

In this case, mechanical processing is performed using a coolant 19, containing water at room temperature as main component, so that the coolant need not be cooled and the need of operating the immersion cooler main body 1 as the coolant cooling apparatus and the cooling pipe 2, and the water temperature sensor 3 may be eliminated.

Thus, in this method, the equipment cost for the immersion cooler main body 1 as well as the time for operation arrangement can be advantageously saved. Also, this method is simple in that a cooling apparatus can be eliminated, and has further advantage that processing is performed at room temperature so that the product (workpiece) is free of warping or dimensional error.

As the coolant is used at room temperature, the coagulating agent 12 must be selected from materials having melting point above room temperature. More specifically, the coagulating agent can be selected from materials having melting point equal to or higher than 30° C., preferably equal to or higher than 40° C. At the same time, when ease of washing away the coagulating agent 12 adhered to the workpiece 13 with water is considered, it is desirable that its melting point is not higher than 100° C.

Other requirements to be satisfied by the coagulating agent 12 include, among others, high adhesive strength to the workpiece 13, no corrosion to metal, no pollution and environmental friendliness and, naturally, low cost.

It has been found after an extensive study that, among water soluble substances, calcium nitrate tetrahydrate (with melting point at 43° C.) selected out of many salt hydrates, and polyethylene glycol, those with molecular weight of 1540 (melting point at 46° C.), 6000 (melting point at 59° C.) and 4000000 (melting point at 66° C.) can be employed. As the melting point of polyethylene glycol becomes higher when molecular weight becomes larger, it has the advantage that a product having suitable melting point can be selected from many commercially available products depending upon the specific application.

As calcium nitrate tetrahydrate and polyethylene glycol are water-soluble, they can be advantageously used as the coagulating agent 12 in that, after completion of mechanical processing, the coagulating agent 12 adhered to the workpiece 13 can be removed by washing with water at room temperature.

It has been found that paraffins are suitable for use as water-insoluble coagulating agents 12. In this case too, various products with melting points ranging from about 42° C. to about 100° C. are commercially available. As paraffins are insoluble in water, they can be advantageously used as coagulating agent in that adhesive strength of the workpiece 13 to the stage is not degraded after lengthy mechanical processing performed while sprinkled coolant 19.

In this case, however, in the removal of the coagulating agent 12 after processing operation, it is necessary to use water-insoluble solvent or hot water at temperature above the melting point to remove paraffin adhered to the workpiece 13. Thus, paraffins require more labor and time compared to water-soluble coagulating agents.

Thus, when mechanical processing is performed using a coolant at ordinary temperature, any one of calcium nitrate tetrahydrate, polyethylene glycol, and paraffin having melting point not lower than ordinary temperature as described above, is used as the coagulating agent 12 to fasten the workpiece 13 to the workpiece-fastening stage (fixing surface) 14 by coagulation of this coagulating agent 12.

As these coagulating agents are naturally solid at room temperature, the workpiece 13 is fastened as follows. First, a warm air stream from a dryer is applied to the workpiece-fastening stage 14 to heat the fixing surface to temperature above melting point of the coagulating agent 12. Then, the coagulating agent 12 in solid state is placed on the fixing surface to be converted into molten state, and the workpiece 13 is placed on the molten coagulating agent.

Then, the coagulating agent is cooled to room temperature and is allowed to solidify to thereby fasten the workpiece 13. A coolant 19 may be sprinkled at room temperature around the workpiece-fastening stage 14 to cool it to room temperature. In order to prevent the molten coagulating agent from flowing out, the coolant 19 should not be sprinkled directly to the workpiece-fastening stage 14 itself but onto the table 15 around the workpiece-fastening stage 14.

Thereafter, in the processing apparatus as shown in FIG. 1, there is no problem in carrying out mechanical processing using the coolant at room temperature. Thus, in the present embodiment, in case where the coolant 19 is used at ordinary temperature, there is no need to cool the workpiece-fastening stage 14 and the coolant 19.

Calcium nitrate tetrahydrate, polyethylene glycol, and paraffins having melting points above ordinary temperature and used as the coagulating agent 12, are inexpensive and friendly to environment and, thus, are unlikely to give rise to pollution. Therefore, a method is provided which is inexpensive compared to conventional methods and is free of environmental contamination. Also, a mechanical processing method is achieved which eliminates the need of a large scale and expensive cooling apparatus.

Examples are shown below in which adhesive strength of the coagulating agent 12 was specifically tested in case where the coolant 19 is used at ordinary temperature. FIG. 3 is a view showing the measuring method of the adhesive strength.

As shown in FIG. 3, a test piece 20 made of stainless steel that does not stick to a magnet was used to measure adhesive strength of the coagulating agent 12. This test piece 20 was fastened via the coagulating agent 12 to the workpiece-fastening stage 14 in the processing apparatus. Adhesion area of the test piece 20 was 1 cm².

The adhesive strength was measured as shear strength by clamping a tensile strength push-pull gauge 21 via a hook 22 to the test piece 20, and by measuring tensile strength when the gauge 21 is gripped with a hand.

### EXAMPLE 1

This Example is a case where a coolant at room temperature and a water-insoluble coagulating agent were used for mechanical processing. A paraffin with a melting point of 69° C. was used as the coagulating agent 12. First, the workpiece-fastening stage 14 was heated with a dryer to 110° C., a temperature higher than the melting point of the paraffin. Then, solid paraffin was placed on the workpiece-fastening stage 14 and was allowed to become completely liquid.

When the liquid paraffin spread to a diameter of about 20 mm, a test piece 20 was placed on the liquid coagulating agent 12. Then, the coolant 19 at room temperature was sprinkled onto the table 15 and the coagulating agent 12 was allowed to coagulate and solidify.

After it was confirmed that the workpiece-fastening stage 14 had reached room temperature, the test piece 20 was pulled with the push-pull gauge 21 until it was separated to measure adhesive strength (shear strength). The mean value of three measurements of adhesive strength conducted in this manner was 22.4 kg/cm².

Further, adhesive strength was measured after aqueous coolant (water soluble grinding fluid, JIS A3-1 equivalent, diluted 50 times) was sprinkled on the adhered surface for 10 minutes, and mean value of three measurements was found to be 19.4 kg/cm². The coagulating agent 12 in the adhered surface did not melt and no change in external appearance was observed. Herein after, throughout the present embodiment, all data on adhesive strength are mean value of three measurements, and sprinkling of the coolant 19 was performed for 10 minutes.

For comparison of the adhesive strength, data of adhesive strength in the case where ice and low-molecular-weight silicone oil of cyclic polydimethyl siloxane (melting point at 17° C.) were used as coagulating agent 12 in prior art, are shown below.

Adhesive strength before a coolant 19 was sprinkled, was 12.6 kg/cm² for ice and 1.7 kg/cm² for the silicone oil. Adhesive strength after a coolant 19 was sprinkled, was 3.1 kg/cm² for the silicone oil. It can be seen from these results that the fastening method of this Example has superior adhesive strength as compared to conventional methods.

### EXAMPLE 2

This Example is a case where a coolant at room temperature and a water-soluble coagulating agent were used for mechanical processing. Polyethylene glycol 1540 (melting point at 46° C.) was used as the coagulating agent. In the same manner as in Example 1 above, the test piece 20 was fastened to the workpiece-fastening stage 14 by melting and coagulation of polyethylene glycol 1540.

In this case, the adhesive strength before the coolant 19 was sprinkled was 4.8 kg/cm². When the coolant 19 was sprinkled for 10 minutes, the coagulating agent 12 around the adhered surface melt gradually, but the adhesive strength after the coolant 19 was sprinkled was 3.1 kg/cm². Thus, an adhesive strength comparable to those of conventional silicone oils was obtained.

### EXAMPLE 3

This Example is also a case where a coolant at room temperature and a water-soluble coagulating agent were used for mechanical processing. Calcium nitrate tetrahydrate (melting point at 43° C.) was used as the coagulating agent. In this Example too, in the same manner as in Example 1 above, the test piece 20 can be fastened to the workpiece-fastening stage 14 by melting and coagulation of calcium nitrate tetrahydrate. As this hydrate tends to give rise to supercooling, it does not solidify even if it is cooled below its melting point. Therefore, solid seed crystals were added to surroundings of the adhesion surface to cause it to be solidified gradually.

Measured adhesive strength was 8.1 kg/cm². When the coolant 19 was sprinkled for 10 minutes, the coagulating agent 12 around the adhered surface began to melt gradually, but the adhesive strength after the coolant 19 was sprinkled was 3.1 kg/cm². Thus, an adhesive strength comparable to those of conventional silicone oils was obtained.

### EXAMPLE 4

This Example is a case where a coolant at room temperature and a paraffin with melting point at 75° C. were used for mechanical processing. The test piece 20 employed was not of stainless steel, but of a fluoride resin.

First, after a workpiece-fastening stage 14 formed of steel S45C was heated with a dryer to about 90° C., a block-shaped paraffin was applied onto the workpiece-fastening stage 14. As the workpiece-fastening stage 14 was heated to temperature above melting point of the paraffin, the paraffin melted and was liquefied as soon as it was applied.

A test piece 20 made of fluoride resin was placed on the molten paraffin, and was left in air at room temperature until the paraffin solidified. After it was confirmed that the test piece 20 made of fluoride resin was fastened to the workpiece-fastening stage 14, the coolant was sprinkled over it to cool the adhered portion to room temperature.

Measurement of adhesive strength with the push-pull gauge yielded a value of 9.7 kg/cm² as mean value of three measurements. Thus, it was found that the present embodiment is also applicable to a fluoride resin that is most resistant to adhesion.

### EXAMPLE 5

Material of the test piece 20 in Example 4 above was replaced with Bakelite and the adhesive strength was measured in the same way as in Example 4. Mean value of three measurements was 13.4 kg/cm².

The resin material constituting the test piece 20 is not restricted to fluoride resin, Bakelite of Examples 4, 5, and may be any other resin such as polypropylene. Special pre-treatment or surface treatment is not required for fluoride resin or the like.

A suitable amount of alumina powder, diatom earth powder, or the like may be added to paraffin as a coagulating agent in order to adjust viscosity, or strength. It was found that, when conventional silicone oil was used as the coagulating agent to fasten fluoride resin or Bakelite, the adhesive strength was 1.1 kg/cm² or 1.3 kg/cm², respectively. This is too small to be used in practice.

[Case Where Coolant Used is Below Ordinary Temperature]

In this case, mechanical processing is carried out using a coolant 19 below ordinary temperature, so that the coolant needs to be cooled, and therefore, mechanical processing is performed in the above-mentioned processing apparatus with the immersion cooler main body 1 and the cooling pipe 2, and the water temperature sensor 3 operated as a coolant cooling apparatus.

Suitable coagulating agents 12 in this case include polyethylene glycol and paraffins with melting points not lower than 0° C. and not higher than room temperature. More specifically, those with melting points not lower than 0° C. and not higher than 20° C. may be selected as coagulating agents.

As has been described above, polyethylene glycol is water-soluble and paraffin is water-insoluble. The melting point becomes lower as molecular weight becomes smaller both for polyethylene glycol and for paraffin, so that a suitable polyethylene glycol or paraffin to be used as the coagulating agent can be selected from commercially available product according to specific application.

Suitable products include polyethylene glycol 400 (melting point at 8° C.), n-paraffin with carbon number 14 (melting point at 5° C.), n-paraffin with carbon number 15 (melting point at 10° C.), n-paraffin with carbon number 16 (melting point at 18° C.), and the like.

At room temperature, these coagulating agents are naturally liquid. As the temperature of an aqueous coolant 19 used is between 0° C. and melting point of the coagulating agent, the coagulating agent 12 is solidified by the cooling action of the coolant 19. The coagulating agent 12 melts when spraying of coolant to the workpiece 13 is stopped. Thus, removal of the coagulating agent 12 can be easily achieved by washing the coagulating agent 12 away with the coolant and it flows through the coolant reception tray 16 to the first sedimention tank 4 together with the coolant.

Polyethylene glycol and paraffin, having melting point not lower than 0° C. and not higher than room temperature as described above, are all substances which are inexpensive, are not corrosive to metals, and are friendly to environment and thus are unlikely to give rise to pollution or adversely effect human health. Alumina powder or diatom earth powder may be added to the coagulating agent 12 in order to adjust the viscosity of the liquid state and to thereby improve workability.

Thus, if mechanical processing is to be carried out using a coolant below ordinary temperature, any one of above-mentioned polyethylene glycol and paraffins having melting point not lower than 0° C. and not higher than ordinary temperature is used as the coagulating agent 12, and after disposing the workpiece 13 and the coagulating agent 12 in liquid state on the workpiece-fastening stage 14 (fixing surface), the coolant 19 is used below ordinary temperature to cause the fastening agent (coagulating agent) to solidify and to thereby fasten the workpiece 13 to the stage.

As these coagulating agents 12 are liquid at room temperature, after the workpiece 13 is disposed on the workpiece-fastening stage 14 via the liquid coagulating agent 12, a coolant 19 below ordinary temperature is used to cool and solidify the coagulating agent 12 before mechanical processing is actually performed.

More specifically, in order to prevent a liquid coagulating agent from flowing out, the coolant 19 below room temperature is sprinkled around the workpiece-fastening stage 14 to thereby cool the workpiece-fastening stage 14 and the coagulating agent 12 below the melting point of the coagulating agent 12. The workpiece 13 can be thereby fastened to the workpiece-fastening stage 14 and there is no problem in performing mechanical processing using the coolant 19 below room temperature.

In this method, in order to solidify the coagulating agent 12, it is necessary to cool the coolant 19 to below room temperature. Though solidification temperature of the coagulating agent 12 is below room temperature, it is not lower than 0° C. so that a large scale cooling apparatus is not required for cooling the coolant and it suffices to use the general purpose immersion cooler 1 of the above-mentioned processing apparatus.

Thus, when a coolant below ordinary temperature is used, any one of polyethylene glycol and paraffins having melting point not lower than 0° C. and not higher than ordinary temperature, can be used as the coagulating agent 12, to thereby provide a method that is inexpensive compared to conventional methods and is free of environmental contamination.

In case where a coolant below ordinary temperature is used, Examples will be shown below in which the adhesive strength of the coagulating agent 12 was specifically measured. The adhesive strength was measured in the same manner as in FIG. 3 above.

### EXAMPLE 6

This Example is a case where a coolant below room temperature and a water-insoluble coagulating agent are used for mechanical processing. n-paraffin of carbon number 16 (melting point at 18° C.) that is liquid at room temperature was used as the coagulating agent.

First, an immersion cooler main body 1 was operated to cool the coolant to 10° C. Paraffin was dripped onto the workpiece-fastening stage 14 in an amount of liquid spreading to a diameter of about 20 mm, and the test piece 20 was placed on the liquid coagulating agent 12. Then, the coolant 19 at temperature of 10° C. was sprinkled on the table 15 and cooled the coagulating agent 12 to solidify.

After it was confirmed that the workpiece-fastening stage 14 reached 10° C., the test piece 20 was pulled with the push-pull gauge 21 until the test piece 20 was separated, and the adhesive strength (shear strength) was measured. Value of adhesive strength was 2.4 kg/cm².

After the coolant 19 at temperature of 10° C. was further sprinkled over the adhered surface for 10 minutes, adhesive strength was measured again and the value of 4.4 kg/cm² was obtained. The coagulating agent 12 at the adhered surface did not melt and did not show any change of external appearance. Thus, in the case of paraffin, there was little difference between adhesive strength before and after sprinkling of the coolant, and an adhesive strength comparable to or higher than conventional silicone oil was obtained.

Washing with water at room temperature suffices to remove this paraffin from the workpiece 13. When this water is cooled to 10° C., solid paraffin appears floating on water surface and needs only to be scooped up for disposal to prevent environmental contamination. A special purpose paraffin detergent, that is friendly to environment, is also available and can be used to remove the coagulating agent adhered to the workpiece 13.

### example 7

This Example is a case where a coolant 19 below room temperature and a water-soluble coagulating agent 12 are used for mechanical processing. Polyethylene glycol 400 (melting point at 8° C.) was used as the coagulating agent 12. Otherwise, the method employed was the same as in Example 6 above, except that temperature of the coolant 19 was set to 4° C.

In this case, adhesive strength before the coolant 19 was sprinkled, was 5.2 kg/cm². Then, the coolant 19 was sprinkled for 10 minutes. Although the coagulating agent 12 began to melt around adhered surface gradually, the adhesive strength after sprinkling of the coolant was 3.4 kg/cm². Thus, adhesive strength comparable to or higher than the conventional level was achieved. Washing with water suffices to remove the coagulating agent 12 from the workpiece 13 after completion of processing.

While the invention has been described by reference to specific embodiments chosen for purpose of illustration, it should be apparent that numerous modifications could be made thereto by those skilled in the art without departing from the basic concept and scope of the invention.

What is claimed is:

1. A method of mechanical processing in which mechanical processing is performed while a coolant is sprinkled over a workpiece fastened to a fixing surface, comprising the steps of:
using any agent having melting point equal to or higher than ordinary temperature and selected from the group consisting of calcium nitrate tetrahydrate, polyethylene glycol, and paraffin, as a fastening agent for fastening said workpiece to said fixing surface,
solidifying said fastening agent to thereby fasten said workpiece to said fixing surface; and
using a coolant at ordinary temperature as said coolant without cooling the coolant.

2. A method of mechanical processing in which mechanical processing is performed while a coolant is sprinkled over a workpiece fastened to a fixing surface, comprising the steps of:
using any agent having melting point not lower than 0° C. and not higher than ordinary temperature and selected from the group consisting of polyethylene glycol and paraffin, as a fastening agent for fastening said workpiece to said fixing surface,
disposing said workpiece and said fastening agent in liquid state on said fixing surface, and using said coolant at temperature not higher than ordinary temperature to solidify said fastening agent to thereby fasten said workpiece to said fixing surface.
